(19) United States
(12) Patent Application Publication
(10) Pub. No.: US 2017/0149748 A1
(43) Pub. Date: May 25, 2017

(54) Secure Group Messaging and Data Steaming

(71) Applicants: Ty Lindteigen, Chandler, AZ (US); Anthony Payne, Chandler, AZ (US); Dipen Patel, Tempe, AZ (US)

(72) Inventors: Ty Lindteigen, Chandler, AZ (US); Anthony Payne, Chandler, AZ (US); Dipen Patel, Tempe, AZ (US)

(21) Appl. No.: 14/952,907

(22) Filed: Nov. 25, 2015

(51) Int. Cl. H04L 29/06; H04L 9/06; H04L 9/08; H04L 29/08; H04L 12/58

(52) U.S. Cl. CPC H04L 63/0435; H04L 67/10; H04L 67/42; H04L 67/303; H04L 51/04; H04L 9/0825; H04L 63/108; H04L 9/0631; H04L 9/0822; H04L 9/065

(57) ABSTRACT

The invention provides novel methods, apparatuses, and systems for securely creating, storing, and transmitting data. The invention enables data exchange between a first and second device. The second device establishes a network session with a first device. An application running on the second device requests the secure messaging service to send a set of application data to the first device via the secure network. The network application initiates a network group session and allocates a relay from the secure messaging service. The first and second device creates an initialization vector and initiates an encrypt cipher stream using the network session key and the initialization vector. The first and second device initiates a decrypt stream using the initialization vector and network session key.

### BACKGROUND

This invention relates generally to the field of data security, and particularly methods, apparatuses, and systems for securely creating, storing, and transmitting data.

Electronic devices generate a significant amount of data. Several applications on such devices generate various types of data that typically need to be shared among many other devices over a communications network. There is a need for such networked applications to securely share the application data to the multiple devices, sometimes simultaneously.

The invention provides novel methods, apparatuses, and systems for securely creating, storing, and transmitting application data.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram illustrating a method and system that enables secure group messaging and data streaming amongst multiple devices via a communication network in accordance with the teachings of the present invention;

FIG. 2 is a diagram illustrating a method to enable asynchronous data exchange amongst multiple devices via a communication network in accordance with the teachings of the present invention;

FIG. 3 is a diagram illustrating a method and system that enables asynchronous data exchange amongst multiple devices in accordance with the teachings of the present invention; and

FIG. 4 is a diagram illustrating the flow of the application data after each member of the network group in accordance with the teachings of the present invention.

### DETAILED DESCRIPTION OF THE DRAWINGS

Although the following descriptions will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

A networked application often has need to securely share the same data to multiple devices, including simultaneously. The data transmittal could be an instant transmission, for example in a voice or video conference call, a delayed transmission, for example such as email or instant messaging, or stored on shared data for long-term repeated access, for example a network hard drive and/or a server for secure file sharing. The invention enables the secure exchange of data without the need for network infrastructure to access the unencrypted data, such as a typical conference bridge or Internet file sharing service. All of the cryptography is executed at the device and/or device's applications and the network infrastructure is used as the secure routing mechanism. In the case of network storage, the storage device and/or server again has no access to the device's data. The device's application can create a secure network group with one or more other application instances. A network key unique to the secure network group is generated by the device. The secure network key is encrypted and sent over the trusted messaging service to the other devices in the secure network group.

For asynchronous communication, the data is symmetrically encrypted using the network session key before transmitting over the trusted messaging service to all devices that are members of the secure network group. The messaging service will hold the encrypted data until retrieved by the device or multiple devices that are members of the secure network group. For streaming connections, the network session key may be used in a symmetric cipher stream (e.g. an AES GCM) which is replicated by the network infrastructure via an packet relay that forwards the data packets that have been encrypted by the devices, but without decrypting the encrypted data packets.

At any time, the creator of the secure network group can generate a new network session key and forward to the members of the secure network group. Likewise, the secure network group membership can be updated, or the group can be disbanded at any time as well.

One embodiment of the invention is a method to enable secure group messaging and data streaming. A first device establishes a secure network session with a second device, wherein the first device and the second device comprise a network group. Next, the first device creates a message and sends the message to the second device over a secure messaging service. The message further comprises a unique identifier for the network group, a human-friendly name for the network group, a list of members of the network group, the owner of the network group, the network session key used by the network group, and a network group state vector. Next the second device includes a network application running on the second device. Finally the network application requests the secure messaging service to send a set of application data to the first device via the secure network session.

One embodiment of the invention is a method that enables an asynchronous data exchange between a first device and a second device over a communication network. First the second device establishes a secure network session with a first device, wherein the first device and the second device comprise a network group. Next the second device creates a message and sends the message to the first device over a secure messaging service, which is connected to the communication network. Next a network application runs on the second device. Finally the network application running on the second device requests the secure messaging service to send a set of application data to the first device via the secure network session.

One embodiment of the invention is a method to enable asynchronous data exchange between a first device and a second device over a communication network. First, the second device establishes a secure network session with a first device, wherein the first device and the second device comprise a network group. Next, the second device creates a message and then the second device sends the message to the first device over a secure messaging service. Next a network application running on the second device requests the secure messaging service to send a set of application data to the first device via the secure network session. Next the network application initiates a network group session and allocates a relay from the secure messaging service that enables the network application to send a relay message to the first device including a relay address and an identification for a relay device. Next the first device and the second device each creates an initialization vector and initializes an encryption cipher stream, such as an Advanced Encryption Standard (AES) Galois Counter Mode (GCM) encrypt cipher stream, using the network session key and the initialization vector. Next the first device and the second device sends a request to connect with the relay. Next the relay completes the request for the first device and the second device. Finally the first device and the second device each initialize an AES GCM decrypt stream using the initialization vector and network session key.

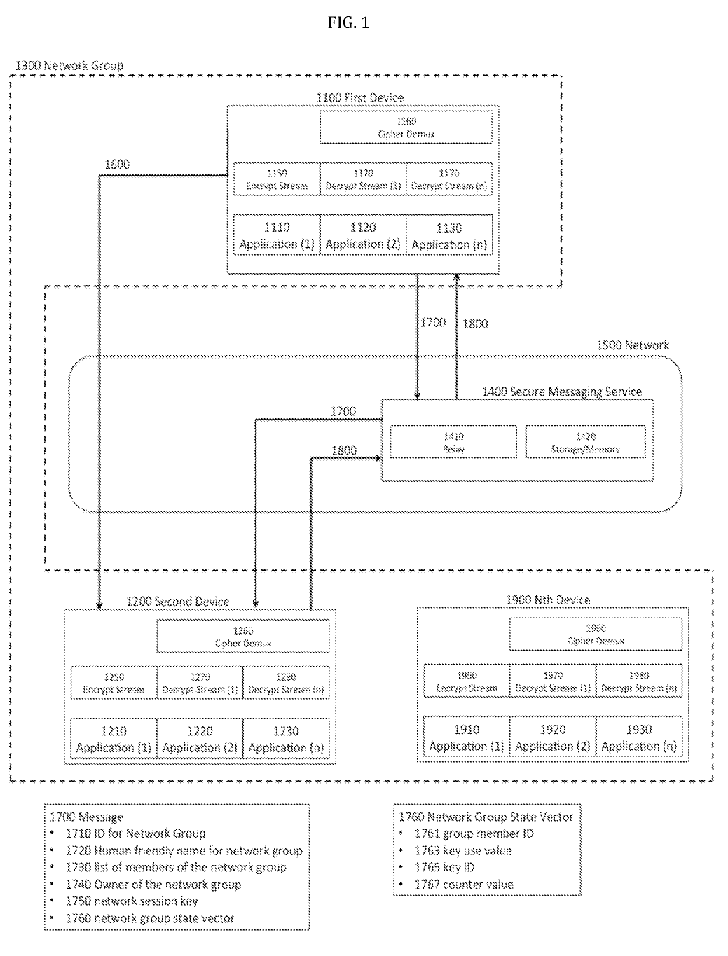

FIG. 1 illustrates a method that enables secure group messaging and data streaming amongst multiple devices via a communication network 1500. A first device 1100 establishes a secure network session 1600 with a second device 1200. In some circumstances, the first device 1100 and/or the second device 1200 may establish a secure network session 1600 with multiple devices (e.g. Nth Device 1900), wherein the first device 1100, the second device 1200, and multiple devices comprise a network group 1300.

Next the first device 1100 creates a message 1700 and sends the message 1700 to the second device 1200 over a secure messaging service 1400 and via the communication network 1500. The message 1700 comprises a unique identifier for the network group 1710, a human-friendly name for the network group 1720, a list of members of the network group 1730, the owner of the network group 1740, the network session key 1750 used by the network group 1300, and a network group state vector 1760. Furthermore the network session key 1750 is asymmetrically encrypted using a private key of the first device and a public key of the second device.

The network group state vector 1760 is used to ensure that a cryptographic operation performed with the network session key 1750 is unique for each member of the group, and across all the groups the device may be a member of. Furthermore, the network group state vector 1760 comprises a group member identifier 1761 that is unique across all devices of the network group 1300, a key use value 1763 that indicates a higher level application, a key identifier 1765 that correlates to a key use instance, and a counter value 1767 that may be monotonically increments each time the network session key 1750 is used by that one member to encrypt the application data 1800. The counter value 1767 can be held in common across all key use values 1763, for example 4-key use values could share a single counter value 1767, or independently incremented for each key use value 1763, for example 4-key use values could have four separate counters. The application data 1800 may be stored within an infrastructure of the secure messaging service 1400 (e.g. the storage/memory 1420) until the second device 1200, or any other devices download a copy of the message and become a member of the network group 1300.

The network session key 1750 (in counter mode) and the key use value 1763 of the network group state vector 1760 (set to a messaging value) are used for encrypting and decrypting the application data 1800 prior to passing the application data 1800 through a cypher. A different network group state vector is used for each key use instance. Furthermore, a different value is used for the key use value to indicate whether the application data 1800 is for an asynchronous message or a data stream.

Finally, the second device 1200 includes a network application 1210 (also more than one application is possible such as 1220 and 1230) running on the second device 1200. The network application 1210 is enabled to request the secure messaging service 1400 to send a set of application data 1800 to the first device 1100 via the secure network session 1600.

In some instances the first device 1100 may need to change the network session key 1750. The network session key 1750 may be changed based on a time-based policy or when a new device is added or dropped from the network group 1300 or when the counter value 1767 in the network group state vector 1760 for a member reaches a maximum value. In such instances the first device 1100 may generate a new network session key and a new message. The new message may comprise a new unique identifier for the network group, a new human-friendly name for the network group, a new list of members of the network group, a new owner of the network group, a new network session key used by the network group, and a new network group state vector. The first device 1100 will send the new message to the second device 1200 and other devices that are members of the secure network group 1300 via the secure messaging service 1400. The second device 1200, and any other device that is a member of the secure network group 1300 that receives the new message, will validate that the new message was sent by the first device 1100.

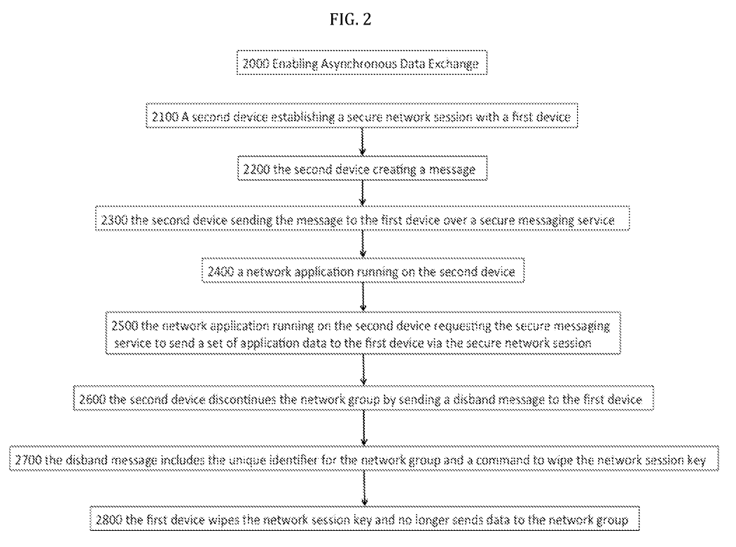

FIG. 2 illustrates a method to enable asynchronous data exchange amongst multiple devices via a communication network. First, a second device establishing a secure network session with a first device forming a secure network group 2100. Next, the second device creates a message 2200 and sends the message to the first device over a secure messaging service 2300. The second device includes a network application running on the second device 2400. The network application running on the second device requests the secure messaging service to send a set of application data to the first device via the secure network session 2500.

Next the second device discontinues the network group by sending a disband message to the first device 2600. The disband message includes a unique identifier for the network group and a command to wipe the network session key 2700. After receiving the command to wipe and confirming that it came from second device, the first device wipes the network session key and no longer sends data to the network group 2800.

The second device includes a network application running on the second device. The network application is enabled to request the secure messaging service to send a set of application data to the first device via a secure network session.

In some instances the first device may need to change the network session key. The network session key may be changed based on a time-based policy or when a new device is added or dropped from the network group or when a counter in the network group state vector for a member reaches a maximum value. In such instances the first device may generate a new network session key and a new message. The new message may comprise a new unique identifier for the network group, a new human-friendly name for the network group, a new list of members of the network group, a new owner of the network group, a new network session key used by the network group, and a new network group state vector. The first device will send the new message to the second device and other devices that are members of the secure network group via the secure messaging service. The second device, and any other device that is a member of the secure network group that receives the new message, will validate that the new message was sent by the first device.

As previously noted and relevant to this embodiment of the invention, the first device and/or the second device may establish a secure network session with multiple devices, wherein the first device, the second device, and multiple devices comprise the network group. The first device creates a message and sends the message to the second device over a secure messaging service and via the communication network. The message comprises a unique identifier for the network group, a human-friendly name for the network group, a list of members of the network group, the owner of the network group, the network session key used by the network group, and a network group state vector. The network session key may be asymmetrically encrypted using a private key of the first device and a public key of the second device, and may be repeated for the remaining N devices in the network group using their respective public keys.

The network group state vector may be used to ensure that a cryptographic operation performed with the network session key is unique. Furthermore, the network group state vector comprises a group member identifier that is unique across all devices of the network group, a key use value that indicates a higher level application, a key identifier that correlates to a key use instance, and a counter value that monotonically increments each time the network session key is used to encrypt the application data. The application data may be stored within an infrastructure of the secure messaging service until the second device, or any other devices download a copy of the message and become a member of the network group. The network session key (in counter mode) and the key use value of the network group state vector (set to a messaging value) are used for encrypting and decrypting the application data prior to passing the application data through a cypher. A different network group state vector may be used for each key use instance. Furthermore, a different value may be used for the key use value to indicate whether the application data is for an asynchronous message or a data stream.

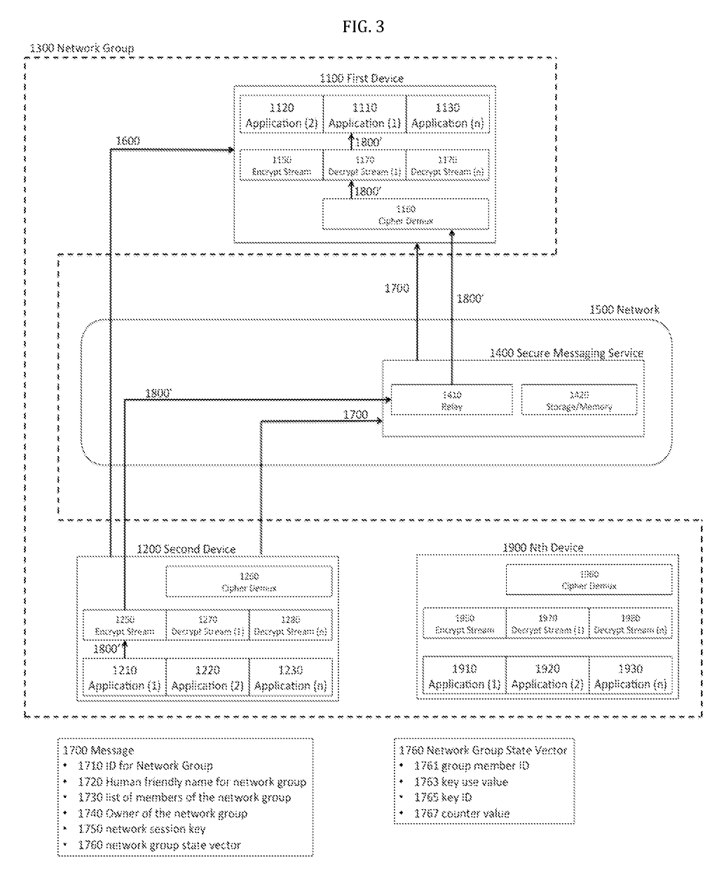

FIG. 3 shows a method that enables asynchronous data exchange amongst multiple devices (e.g. first device 1100, second device 1200, and Nth device 1900) over a communication network 1500. A second device 1200 establishes a secure network session 1600 with a first device 1100, wherein the first device 1100 and the second device 1200 comprise a network group 1300. Alternatively the first device 1100 and the second device 1200 may establish a secure network connection with any number of other devices (e.g. Nth device 1900) and add such other devices to the network group 1300. Next the second device 1200 creates a message 1700. Next the second device 1200 sends the message 1700 to the first device 1100 over a secure messaging service 1400. The second device 1200 includes a network application 1210 (and possibly other applications 1220 and 1230) running on the second device 1200. The network application 1210 requests the secure messaging service 1400 to send a set of application data 1800 to the first device 1200 via the secure network 1500. Next the network application 1210 initiates a network group session and allocates a relay 1410 from the secure messaging service 1400 thus enabling the network application 1210 to send a relay message to the first device including a relay address and a relay identification. Next, the first device 1100 and the second device 1200 each creates an initialization vector, subsequently referred to as the network group state vector 1760, and initiates an Advanced Encryption Standard (AES) Galois Counter Mode (GCM) encrypt cipher stream 1250 using the network session key 1750 and the network group state vector 1760. Next the first device 1100 and the second device 1200 send a request to connect with the relay device 1410. Next the relay device 1410 connects the request for the first device 1100 and the second device 1200. Finally the first device 1100 and the second device 1200 each initiates an AES GCM decrypt stream (e.g. 1170, 1180, 1270, 1280) using the network group state vector 1760 and network session key 1750.

As previously noted and relevant to this embodiment of the invention, the first device 1100 and/or the second device 1200 may establish a secure network session with multiple devices (e.g. Nth device 1900), wherein the first device 1100, the second device 1200, and multiple devices (e.g. Nth device 1900) comprise the network group 1300. The second device 1200 creates a message 1700 and sends the message 1700 to the first device 1100 over a secure messaging service 1400 and via the communication network 1500. The message 1700 comprises a unique identifier for the network group 1710, a human-friendly name for the network group 1720, a list of members of the network group 1730, the owner of the network group 1740, the network session key 1750 used by the network group 1300, and a network group state vector 1760. The network session key 1750 may be asymmetrically encrypted using a private key of the first device 1100 and a public key of the second device 1200.

The network group state vector 1760 may be used to ensure that a cryptographic operation performed with the network session key 1750 is unique. Furthermore, the network group state vector 1760 comprises a group member identifier 1761 that is unique across all devices of the network group 1300, a key use value 1763 that indicates a higher level application, a key identifier 1765 that correlates to a key use instance, and a counter value 1767 that monotonically increments each time the network session key 1750 is used to encrypt the application data 1800. The application data 1800 may be stored within an infrastructure of the secure messaging service (e.g. the storage/memory 1420) until the second device 1200, or any other devices download a copy of the message and become a member of the network group 1300. The network session key 1750 (in counter mode) and the key use value 1763 of the network group state vector 1760 (set to a messaging value) are used for encrypting and decrypting the application data 1800 prior to passing the application data 1800 through a cypher. A different network group state vector may be used for each key use instance. Furthermore, a different value may be used for the key use value to indicate whether the application data is for an asynchronous message or a data stream.

FIG. 1 illustrates the invention comprising a system enabled to asynchronously exchange data between an ad hoc subset of devices. The system comprises a first device 1100, a second device 1200, and any number of other devices (e.g. the Nth device 1900). The first device 1100, the second device 1200, and the other devices each include an application (e.g. 1120, 1210, 1910) running on the device, a cipher device enabled to generate an encryption stream (e.g. 1150, 1250, 1950), a cipher demux (e.g. 1160, 1260, 1960), and cipher device enabled to generate a decryption stream (e.g. 1170, 1270, 1970). Next the first device 1100, the second device 1200, and the other devices are coupled to a communication network 1500. Next a secure messaging service 1400 is coupled to the communication network 1500. The secure messaging service 1400 also includes a relay device 1410. The secure messaging service 1400 is also coupled to the first device 1100, the second device 1200, and the other devices.

Furthermore the first device 1100 is configured to secure an authenticated communication session 1600 between the second device 1200, the secure messaging service 1400, and any number of other devices at start up, or at periodic intervals, or upon request. The secure and authenticated communication links may be established using standard cryptographic techniques over the communication network 1500. The network 1500 may be either a wired or wireless communication network. The network 1500 may include a public or private network such as the internet, intranet, telecommunications system, secure messaging service, or other network capable of transmitting electronic data.

The first device 1100, the second device 1200, the other devices, and the secure messaging service 1400 may include internal hardware such as a processor, memory, and communication features. The first device 1100, the second device 1200, the other devices, and the secure messaging service 1400 may include software applications enabled to encrypt and decrypt data before sending the data through the network 1500. The data encryption may be accomplished using any data encryption method such as Advanced Encryption Standard (“AES”).

The first device 1100, the second device 1200, the other devices, and the secure messaging service 1400 may include smart phones, tablet PC's, notebook PC's, desktop PC's, remote monitoring devices, cameras, or sensors. Such devices may be used for any type of communication, computing, or electronic operation. Furthermore, such devices may comprise a physical storage device such as a hard drive, series of hard drives, SSD memory, SD Card, or any other type of local volatile or non-volatile memory. The secure messaging 1400 service may also include a remote cloud storage service, such as Amazon Storage, Google Cloud Storage, or any other commercially available remote network storage service. The invention is also applicable to both mobile devices and fixed devices since either type are commonly used to transmit data to and from other mobile and fixed devices via a communication network.

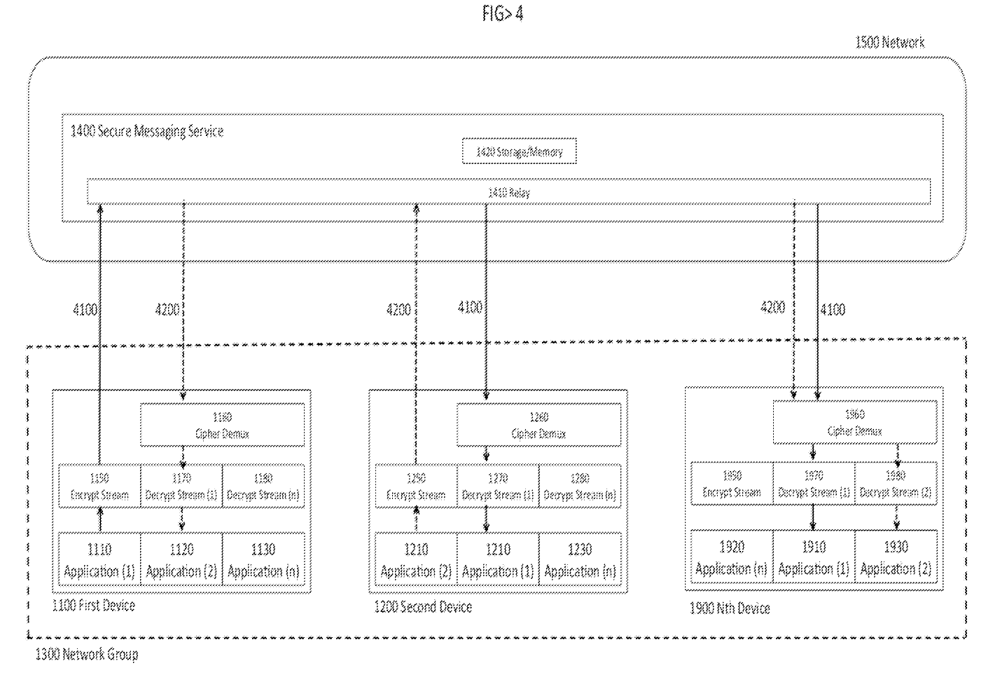

FIG. 4 illustrates the flow of the application data (e.g. 4100 originating from the first device 1100 and 4200 originating from the second device 4200) after each member of the network group 1300 creates an AES GCM encrypt cipher stream. For example, the application 1110 of the first device 1100 sends a first application data 4100 through the encrypt stream 1150 of the first device 1100 to produce an encrypted first application data. The first device 1100 then sends the encrypted first application data 4100 through the communication network 1500, and to the relay 1410. The relay device 1410 only sees the encrypted first application data 4100 from the first device 1100. The relay 1410 replicates the encrypted first application data 4100 to the other devices and is not enabled to decrypt and read the encrypted first application data 4100. The relay 1410 sends the encrypted first application data 4100 to a cipher demux 1260 of the second device 1200, and alternately to the cipher demux for any number of other devices (e.g. cipher demux 1960 of the Nth device 1900) that are members of the secure network group 1300. The cipher demux 1260 of the second device 1200 receives the encrypted first application data 4100 and routes the encrypted first application data 4100 to the appropriate AES GCM decrypt steam 1270 for decryption to produce the decrypted first application data. The decrypted first application data is sent to the application 1210 with a stream identifier for further processing.

The process may be repeated in a similar fashion when an application 1220 of the second device 1200 sends a second application data 4200 through a second encrypt stream 1250 to produce an encrypted second application data 4200. The second device 1200 then sends the encrypted second application data 4200 through the communication network 1500, and to the relay device 1410. The relay 1410 again only sees the encrypted second application data 4200 from the second device 1200. The relay 1410 replicates the encrypted second application data 4200 to the other devices (e.g. the first device 1100 and the nth device 1900) and is not enabled to decrypt and read the encrypted second application data 4200. The relay 1410 sends the encrypted second application data 4200 to a cipher demux 1160 of the first device 1100, and alternately to the cipher demux for any number of other devices that are members of the secure network group 1300. The cipher demux 1160 of the first device 1100 receives the encrypted second application data 4200 and routes the encrypted second application data 4200 to the appropriate AES GCM decrypt steam 1170 for decryption to produce the decrypted second application data. The decrypted second application data 4200 is sent to the application 1120 with a stream identifier for further processing. Again the process can be repeated for any other members of the secure network group 1300, for any number of applications, and any amount of application data.

The invention enables application data to be sent to members of the network group such that the same network session key can be used for multiple applications. For example, the invention enables use of an asynchronous messaging and a group streaming application without a separate key exchange for each application. Furthermore, the network group state vector is unique across all members of the network group so there is no chance of the same network session key and counter combination being used for an encryption operation. In addition, in a system that uses multiple, geographically dispersed servers for the asynchronous messaging service, it is possible for the application data to be delivered in a different order than the application data is sent. Furthermore, the network group state vector combined with the use of the group network key in counter mode enables each message to be decrypted independently and without requiring the knowledge of the other encrypted messages.

Throughout this description the first device, the second device, and the secure messaging service have been described as devices, however software components can also be used to perform the actions of any of such devices. Furthermore, the cryptographic components enabled to perform encryption and decryption may rely on asymmetric cryptography. For example, AES-GCM encryption has been described, but other methods may be used such as ECDH for key agreements, use of shared secrets, hard coded passwords, and one-time pads.

Throughout this description, references were made to devices coupled together. Such coupling includes a manner that allows the exchange and interaction of data, such that the operations and processes described may be carried out. For example, the devices may be coupled with electrical circuitry, or through wireless networks that allow the devices to transfer data, receive power, execute the operations described, and provide structural integrity. Reference was also made to interactions amongst devices via a network, however the invention is scalable to be enabled with any number of devices, servers, and/or computers than described in the specification. For example, any number of devices, networks, and servers, and/or computers may be utilized to enable this invention.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

The hereinafter expressed claims are hereby expressly incorporated into this Detailed Specification, with each claim standing on its own as a separate embodiment of the invention. Furthermore, while some embodiments described herein include some but not other features included in other embodiments, combinations of features of different embodiments are meant to be within the scope of the invention, and form different embodiments, as would be understood by those skilled in the art.

What is claimed is:

1. A method to enable secure group messaging and data streaming comprising:
a first device establishing a secure network session with a second device, wherein the first device and the second device comprise a network group;
the first device creating a message;
the first device sending the message to the second device over a secure messaging service;
a network application running on the second device; and
the network application requesting the secure messaging service to send a set of application data to the first device via the secure network session.

2. The method of claim 1 wherein the message comprises a unique identifier for the network group, a human-friendly name for the network group, a list of members of the network group, the owner of the network group, the network session key used by the network group, and a network group state vector.

3. The method of claim 2 wherein the network group state vector is used to ensure that a cryptographic operation performed with the network session key is unique.

4. The method of claim 3 wherein the network group state vector comprises a group member identifier that is unique across all devices of the network group, a key use value that indicates a higher level application, a key identifier that correlates to a key use instance, and a counter value that monotonically increments each time the network session key is used to encrypt the application data.

5. The method of claim 4 wherein the network session key in counter mode and the key use value of the network group state vector set to a messaging value is used for encrypting and decrypting the application data prior to passing the application data through a cipher.

6. The method of claim 4 wherein there is a different network group state vector for each key use instance.

7. The method of claim 4 wherein a different value is used for the key use value to indicate application data types, such as an asynchronous message or a data stream.

8. The method of claim 1 wherein the network session key is asymmetrically encrypted using a private key of the first device and a public key of the second device.

9. The method of claim 1 wherein the first device changes the network session key.

10. The method of claim 9 wherein the network session key is changed based on a time-based policy or when a new device is added or dropped from the network group or when a counter in the network group state vector reaches a maximum value.

11. The method of claim 1 wherein the first device generates a new network session key and a new message.

12. The method of claim 11 wherein the new message comprises a new unique identifier for the network group, a new human-friendly name for the network group, a new list of members of the network group, a new owner of the network group, a new network session key used by the network group.

13. The method of claim 11 wherein the first device sends the new message to the first device over the secure messaging service.

14. The method of claim 13 wherein the second device validates that the new message was sent by the first device.

15. The method of claim 1 wherein the application data is stored within an infrastructure of the secure messaging service until the first device downloads a copy of the message and becomes a member of the network group.

16. A method to enable asynchronous data exchange comprising:
a second device establishing a secure network session with a first device, wherein the first device and the second device comprise a network group;
the second device creating a message;
the second device sending the message to the first device over a secure messaging service;
a network application running on the second device; and
the network application running on the second device requesting the secure messaging service to send a set of application data to the first device via the secure network session.

17. The method of claim 16 wherein the second device discontinues the network group by sending a disband message to the first device.

18. The method of claim 17 wherein the disband message includes the unique identifier for the network group and a command to wipe the network session key.

19. The method of claim 16 wherein the first device wipes the network session key and no longer sends data to the network group.

20. A method to enable synchronous data exchange comprising:
a second device establishing a secure network session with a first device, wherein the first device and the second device comprise a network group;
the second device creating a message;
the second device sending the message to the first device over a secure messaging service;
a network application running on the second device;
the network application requesting the secure messaging service to send a set of application data to the first device via the secure network session;
the network application initiating a network group session and allocating a relay from the secure messaging service and enabling the network application to send a relay message to the first device including a relay address and a relay identification;
the first device and the second device each creating an initialization vector and initiating a symmetric encrypt cipher stream using the network session key and the initialization vector;
the first device and the second device sending a request to connect with the relay;
the relay connecting the request for the first device and the second device; and
the first device and the second device each initializing a symmetric decrypt cipher stream using the initialization vector and network session key.
